(19) United States
(12) Patent Application Publication
(10) Pub. No.: US 2026/0251816 A1
(43) Pub. Date: Aug. 27, 2026

(54) METHOD FOR SIMULATING TRANSPORT OF REACTIVE SOLUTE IN GROUNDWATER IN THREE-DIMENSIONAL FRACTURE NETWORK AND SYSTEM THEREOF

(71) Applicants: HOHAI UNIVERSITY, Jiangsu (CN); NANJING UNIVERSITY, Jiangsu (CN)

(72) Inventors: Yun YANG, Jiangsu (CN); Jinguo WANG, Jiangsu (CN); Jianfeng WU, Jiangsu (CN); Jian SONG, Jiangsu (CN); Zhou CHEN, Jiangsu (CN); Zhi DOU, Jiangsu (CN)

(73) Assignees: HOHAI UNIVERSITY, Jiangsu (CN); NANJING UNIVERSITY, Jiangsu (CN)

(21) Appl. No.: 18/870,467

(22) PCT Filed: Nov. 23, 2023
(86) PCT No.: PCT/CN2023/133510

§ 371 Date: Nov. 29, 2024

(30) Foreign Application Priority Data
Sep. 20, 2023 (CN) 202311215831.6

(51) Int. Cl. G01V 20/00; G06F 30/28

(52) U.S. Cl. CPC G01V 20/00; G06F 30/28

(57) ABSTRACT

A method for simulating a transport of a reactive solute in groundwater in a three-dimensional fracture network, which is utilized for simulating a reaction transport rule of the solute in the groundwater in the fracture medium. The method provided in the present disclosure includes the following steps. The transport of the reactive solute in the fracture groundwater and the hydraulic connection between the fracture and the surrounding wall-rock are considered, a model that is utilized for coupling the water flow field and the chemical field is constructed, and a simulation of the transport values for the reactive solute in the groundwater in the three-dimensional fracture network is performed. The simulation technology provided in the present disclosure can provide the scientific and reasonable theoretical basic for the research on the spatiotemporal distribution of the reaction transport of the target solute in the groundwater in the fracture network.

### TECHNICAL FIELD

The present disclosure relates to a method for simulating a transport of a reactive solute in groundwater in a three-dimensional fracture network and a system thereof, which belongs to the field of the earth science and the engineering.

### BACKGROUND

In regions with the relatively developed fracture networks, the transport process of the reactive solute in the medium in the aquifer is extremely complex. The researches on the transport and the transformation rule of the solute in the bedrock fracture water are closely related to the assessment and the prediction of the pollution of the fracture water, the risk assessment of the geological disposal of the nuclear waste and the greenhouse gases. How to quantitatively characterize the rule of the transport of the reactive solute in the fracture medium is permanently the hotspot and the difficulty in the research of the international water environment and the hydrogeological field. Different from the mechanism of the transport of the inert solute, the transport of the reactive solute is a complex process that requires to consider the water flow movement, the solute transport, and the chemical reaction simultaneously, and the complexity of the transport of the reactive solute is especially obvious in the fracture medium with the strong heterogeneity. The transportation of the reactive solute in the fracture medium exhibits an “abnormal” transportation that deviates from a transportation and characterized by the traditional reactive convection-dispersion equation, which exhibits the characteristics such as the early arrival and the tailing of the products, and the concentration of the products lower than the predicted concentration, thereby resulting in the practical problems such as the extension of the repair cycle of the pollutants, the repair efficiency lower than the predict efficiency. In recent years, China and foreign researches indicate that the fracture rock matrix is an important hydrogeochemical buffer region, which has a significant blocking effect on the transport process of the solute in the surrounding fracture medium. Considering the geochemical reaction and the mass exchange between these two regions is the key to accurately characterize the overall buffering capacity of the fracture groundwater in one region and the associated hydrogeochemical evolution process.

However, the current research mainly researches the reactive transport process in small-scale fracture medium through the indoor experiments and the models, and the quantitative characterization on the transport process of the reactive solute in the fracture groundwater at large scale is extremely fewer. The method proposed by the present disclosure can consider the influences of the fracture and the fracture rock mass on the transport of the groundwater solute, effectively characterize the spatiotemporal variation rule of the transport of the reactive solute in the groundwater in the three-dimensional fracture network, which provides the key information of the region for the monitoring of the groundwater pollution, thereby better guiding the on-site works of the transport, the diffusion as well as the prevention and control of the pollutants, in the fracture development region and the subsequent repair and treatments.

### SUMMARY

The objectives of the present disclosure are as follows. In view of the disadvantages of the above-mentioned prior art, the objectives of the present disclosure are to provide a method for simulating a transport of a reactive solute in groundwater in a three-dimensional fracture network and a system thereof. The method can consider the transport of the reactive solute in the fracture groundwater and the hydraulic connection between the fracture and the surrounding wall-rock, construct a model that is utilized for coupling the water flow field and the chemical field, and perform a simulation of the transport values for the reactive solute in the groundwater in the three-dimensional fracture network.

The technical solutions are as follows. A method for simulating a transport of a reactive solute in groundwater in a three-dimensional fracture network is provided in the present disclosure. The method comprises the following steps.

In Step SS1, geological structure data of a fracture block in a target research region and local hydrogeological parameters for the target research region are collected.

In Step SS2, the geological structure data are modeled and parameterized according to the geological structure data collected by Step SS1, lithology parameters for a stratum are set, a discrete fracture network is generated, and a plane fracture grid is upscaled to a three-dimensional cubic grid, the three-dimensional cubic grid is mapped into an equivalent continuum porous medium, then the equivalent continuum porous medium is divided into a three-dimensional fracture body grid to establish a geological structure model for the research region.

In Step SS3, an initial water head condition, a boundary condition, and permeability coefficients for a fracture and a fracture body of the geological structure model are determined based on the geological structure model established by Step SS2, according to the collected hydrogeological parameters, a spatiotemporal distribution of a groundwater level in the research region is solved, and an initial groundwater flow field is obtained.

In Step SS4, physical and chemical parameters for pollutants and a source-sink phase condition are set based on the initial groundwater flow field obtained by Step SS3, and a spatiotemporal distribution of a solute concentration in fracture groundwater is determined.

In Step SS5, relevant chemical reaction parameters are set based on a solute transport model obtained by Step SS4, and a water flow field and a chemical flow field are coupled to each other according to a basic equation of a mass and energy conservation, a seepage field equation, and a solute transport control equation, a result for a transport of the reactive solute in the fracture medium driven by a hydrodynamic and a hydrogeochemical reaction is solved, and a simulation of transport values for the reactive solute in the groundwater in the three-dimensional fracture network is completed.

Further, in Step SS1, the data include (1) a hydrogeological condition, a stratum lithology, a stratum thickness, an aquifer buried depth, an aquiclude buried depth, an aquifer thickness, an aquiclude thickness, spatial distributions of the aquifer and the aquiclude, a recharge-runoff-discharge condition of a hydrogeological unit, a groundwater ion content, groundwater flow rate and velocity, and a hydrogeochemical characteristic; (2) a fracture medium condition, an overall number of the fractures, a spatial distribution for the fractures, a fracture occurrence, an opening degree of the fracture, a fracture development depth, a fracture roughness, physical and chemical properties of a fracture filling and a fracture geological body, and a spatial distribution of the permeability coefficient for the fracture network, in the target research region.

Further, in Step SS2, the three-dimensional fracture network model is established as follows.

Characteristic parameters for the three-dimensional fracture network geological structure model are determined by a discrete fracture network parameter control equation and a model upscaling grid division control equation.
(1) In the discrete fracture network parameter control equation,
   a. a direction of a normal vector for a fracture surface is characterized by a von Mises-Fisher distribution function, specifically,

$$\overline{v} = = \frac{κ \cdot {e}^{κ \cdot {\overline{v}}^{T} \cdot I}}{2 π ( {e}^{κ} - {e}^{- κ} )} \qquad ( 1 )$$

where \tilde{ν} denotes a matrix of a mean normal vector for the fracture, κ denotes a density coefficient, T denotes a matrix transpose, and I denotes an identity matrix;
b. a truncated power law distribution is adopted by a fracture radius R, and the fracture radius R is defined by the following probability density function,

$$R = {( \frac{α}{{R}_{1}^{- α} - {R}_{u}^{- α}} )}^{- 2 - α} \qquad ( 2 )$$

where Ru denotes an upper boundary of the fracture radius, Rl denotes a lower boundary of the fracture radius, and a denotes a constant coefficient;
c. a fracture opening degree φ is determined by an exponential function of the fracture radius, specifically,

$$ϕ = F \cdot {R}^{γ} \qquad ( 3 )$$

where both F and γ denote the parameter values related to the water permeability;
d. a fracture permeability k is calculated based on the fracture opening degree φ, specifically,

$$k = \frac{{ϕ}^{2}}{12} \qquad ( 4 )$$

(2) In the model upscaling grid division control equation,
   a. a fracture medium porosity n is calculated based on an opening degree of the fracture passing through each grid, specifically,

$$n = \frac{1}{l} {{\sum }_{i = 1}}^{N} {ϕ}_{i} \qquad ( 5 )$$

where l denotes a side length of a divided grid, N denotes a total number of the fractures passing through the divided grid, φᵢ denotes an opening degree of an i-th fracture in a target grid and is calculated by Formula (3);
b. a fracture medium permeability k_{f} is assigned with reference to a permeability of each fracture in the grid, specifically,

$${k}_{f} = {{\sum }_{i = 1}}^{N} {k}_{i} \qquad ( 6 )$$

where kᵢ denotes a permeability of the i-th fracture in the target grid and is calculated by Formula (4).

Further, in Step SS4, the set parameters for the pollutants include the groundwater background ion component, a groundwater background ion concentration, a pollution source ion component, a pollution source ion concentration and a condition of a boundary of a source-sink phase. In Step SS5, the chemical reaction parameters include a reaction equation of a groundwater ion component, a reaction equilibrium constant of the groundwater ion component, a mineral component, a mineral volume fraction, a mineral reaction rate constant, and a mineral phase specific surface area.

Further, in Step SS5, the groundwater reactive solute transport model is constructed as follows.

A spatiotemporal evolution law of a target pollutants in the model driven by the hydrodynamic and the hydrogeochemical action is calculated and obtained by the seepage field equation, the solute transport control equation, and the mass and energy conservation equation.
a. The seepage field equation is:

$$\frac{\partial }{\partial t} ( ns ρ ) - ∇ ( ρ \frac{{kk}_{r}}{μ} ∇ ( P - ρ gz ) ) = w , \qquad ( 7 )$$

where n denotes a porosity, s denotes a saturation, ρ denotes a fluid density, w denotes an infiltration supply volume, k denotes an absolute permeability, kᵣ denotes a relative permeability, μ denotes a fluid viscosity coefficient, P denotes a pressure, g denotes a gravity acceleration and z denotes an elevation water head.
b. The solute transport control equation is derived according to a mass conservation law of mass and is represented as follows:

$$\frac{\partial ( n ( {C}_{j} + {\sum }_{i = 1}^{{N}_{i}} {v}_{ji} {C}_{i}^{′} ) )}{\partial t} + ∇ ( q - nsD ∇ ) ( {C}_{j} + {{\sum }_{i = 1}}^{{N}_{i}} {v}_{ji} {C}_{i}^{′} ) = {Q}_{j} - {{\sum }_{m = 1}}^{M} {v}_{jm}^{′} {I}_{m} \qquad ( 8 )$$

where Cⱼ denotes a concentration of particles j, Cᵢ′ denotes a concentration of secondary species particles i corresponding to the particles j, Uji denotes a stoichiometric number of all particles j and particles i related to liquid phase reactions, Nᵢ denotes a total number of the secondary species particles i, q denotes a groundwater flow velocity, D denotes a molecular diffusion tensor, Qⱼ denotes a source-sink phase of the particles j, Im denotes a mineral reaction rate, νⱼₘ′ denotes a stoichiometric number of the particles j related to mineral phase reactions, M denotes a total number of the particles j related to the mineral phase reactions, the particle j denotes a particle with a largest relative concentration in a liquid phase, the secondary species particle i corresponding to particle j denotes a particle of the particle j that is ionized or combined with other groups of the particles in the liquid phase, for example, when the particle j is Ca²⁺, the secondary species particle i corresponding to the particle j includes such as CaCO3(aq), CaHCO₃⁺, Ca(OH)⁺, CaCl⁺, CaCl_{2(aq)} and CaSO₄(aq), and when the particle j is HCO₃₋, the secondary species particle i corresponding to the particle j includes such as CO₃²⁻, CO_{2(aq)}.
c. A mineral phase reaction rate Im is obtained and calculated by the mass conservation law, specifically,

$${I}_{m} = \frac{1}{{\overline{V}}_{m}} \frac{\partial {φ}_{m}}{\partial t} \qquad ( 9 )$$

where φₘ denotes a mineral volume fraction, V̅ₘ denotes a mineral molar volume.
d. A quantitative relation between the concentration Cⱼ of the particles j of a same type and the concentration Cᵢ′ of the secondary species particles i corresponding to the particles j is obtained according to a mass and energy conservation law of an equilibrium reaction, specifically,

$${C}_{i}^{′} \frac{{γ}_{i}}{{K}_{i}} = {\prod }_{j} {( {γ}_{j} {C}_{j} )}^{{v}_{ji}} \qquad ( 10 )$$

where Kᵢ denotes a reaction equilibrium constant of the secondary species particles i, γⱼ denotes an activity coefficient for the particles j and γᵢ denotes an activity coefficient for the secondary species particles i corresponding to the particles j.

A system for simulating a transport of a reactive solute in the groundwater in a three-dimensional fracture network is further provided by the present disclosure. The system includes a model parameter collection module, a three-dimensional fracture network construction module, a groundwater flow module, a solute transport module and a fracture reaction transport module.

The model parameter collection module is configured to collect the geological structure data of a fracture block in a target research region and local hydrogeological parameters for the target research region.

The three-dimensional fracture network construction module is configured to model and parameterize the geological structure data according to the collected geological structure data, set lithology parameters for a stratum, generate a discrete fracture network, and upscale a plane fracture grid to a three-dimensional cubic grid and map the three-dimensional cubic grid into an equivalent continuum porous medium and divide the equivalent continuum porous medium into a three-dimensional fracture body grid to establish the geological structure model for the research region.

The groundwater flow module is configured to determine an initial water head condition, a boundary condition, permeability coefficients for a fracture and a fracture body of the geological structure model based on the established geological structure model according to the collected hydrogeological parameters, a spatiotemporal distribution of a groundwater level in the research region is solved, and an initial groundwater flow field is obtained.

The solute transport module is configured to set physical and chemical parameters for pollutants and a source-sink phase condition based on the obtained initial groundwater flow field, and determine a spatiotemporal distribution of a solute concentration in fracture groundwater.

The fracture reaction transport module is configured to set relevant chemical reaction parameters based on the solute transport model, and couple a water flow field and a chemical flow field according to a basic equation of a mass and energy conservation, a seepage field equation, and a solute transport control equation, solve a result for the transport of the reactive solute in a fracture medium driven by a hydrodynamic and a hydrogeochemical reaction, and complete a simulation of transport values for the reactive solute in the groundwater in the three-dimensional fracture network.

Further, the data include (1) a hydrogeological condition, a stratum lithology, a stratum thickness, an aquifer buried depth, an aquiclude buried depth, an aquifer thickness, an aquiclude thickness, spatial distributions of the aquifer and the aquiclude, a recharge-runoff-discharge condition of a hydrogeological unit, a groundwater ion content, groundwater flow rate and velocity, and a hydrogeochemical characteristic; (2) a fracture medium condition, an overall number of the fractures, a spatial distribution of the fractures, a fracture occurrence, a fracture opening degree, a fracture development depth, a fracture roughness, physical and chemical properties of a fracture filling and a fracture geological body, and a spatial distribution of the permeability coefficients for a fracture network, in the target research region.

Further, the three-dimensional fracture network model is constructed as follows.

Characteristic parameters for the three-dimensional fracture network geological structure model are determined by a discrete fracture network parameter control equation and a model upscaling grid division control equation.
(1) In the discrete fracture network parameter control equation,
   a. a direction of a normal vector for a fracture surface is characterized by a von Mises-Fisher distribution function, specifically,

$$\overline{v} = = \frac{κ \cdot {e}^{κ \cdot {\overline{v}}^{T} \cdot I}}{2 π ( {e}^{κ} - {e}^{- κ} )} \qquad ( 1 )$$

where ν̅ denotes a matrix of a mean normal vector for the the fracture, κ denotes a density coefficient, T denotes a matrix transpose, and I denotes an identity matrix.
b. a truncated power law distribution is adopted by a fracture radius R, and the fracture radius R is defined by a following probability density function,

$$R = {( \frac{α}{{R}_{1}^{- α} - {R}_{u}^{- α}} )}^{- 2 - α} \qquad ( 2 )$$

where Rᵤ denotes an upper boundary of the fracture radius, Rₗ denotes a lower boundary of the fracture radius, and a denotes a constant coefficient.
c. a fracture opening degree φ is determined by an exponential function of the fracture radius,

$$ϕ = F \cdot {R}^{γ} \qquad ( 3 )$$

where both F and γ denote the parameter values related to a water permeability.
d. a fracture permeability k is calculated based on the fracture opening degree, specifically,

$$k = \frac{{ϕ}^{2}}{12} \qquad ( 4 )$$

(2) In the model upscaling grid division control equation,
   a. a fractured medium porosity n is calculated based on an opening degree of the fracture passing through each grid, specifically,

$$n = \frac{1}{l} {{\sum }_{i = 1}}^{N} {ϕ}_{i} \qquad ( 5 )$$

where l denotes a side length of a divided grid, N denotes a total number of the fractures passing through the divided grid, and di denotes an opening degree of an i-th fracture in a target grid and is calculated by Formula (3);
b. the fracture medium permeability k_{f} is assigned with reference to a permeability of each fracture in the grid, specifically,

$${k}_{f} = {{\sum }_{i = 1}}^{N} {k}_{i} \qquad ( 6 )$$

where kᵢ denotes a permeability of the i-th fracture in the target grid and is calculated by Formula (4).

Further, the set parameters for the pollutants include the groundwater background ion component, a groundwater background ion concentration, a pollution source ion component, a pollution source ion concentration, and a condition of a boundary of a source-sink phase. In Step SS5, the chemical reaction parameters include a reaction equation of a groundwater ion component, a reaction equilibrium constant of the groundwater ion component, a mineral component, a mineral volume fraction, a mineral reaction rate constant, and a mineral phase specific surface area.

Further, the groundwater reactive solute transport model is constructed as follow.

A spatiotemporal evolution law of target pollutants in the model driven by the hydrodynamic and the hydrogeochemical action is calculated and obtained by the seepage field equation, the solute transport control equation, and the mass and energy conservation equation.
a. The seepage field equation is as follows:

$$\frac{\partial }{\partial t} ( ns ρ ) - ∇ ( ρ \frac{{kk}_{r}}{μ} ∇ ( P - ρ gz ) ) = w \qquad ( 7 )$$

where n denotes a porosity, s denotes a saturation, ρ denotes a fluid density, w denotes an infiltration supply volume, k denotes an absolute permeability, kᵣ denotes a relative permeability, μ denotes a fluid viscosity coefficient, P denotes a pressure, g denotes a gravity acceleration and z denotes an elevation water head.
b. The solute transport control equation is derived according to a mass conservation law and is represented as follows:

$$\frac{\partial ( n ( {C}_{j} + {\sum }_{i = 1}^{{N}_{i}} {v}_{ji} {C}_{i}^{′} ) )}{\partial t} + ∇ ( q - nsD ∇ ) ( {C}_{j} + {{\sum }_{i = 1}}^{{N}_{i}} {v}_{ji} {C}_{i}^{′} ) = {Q}_{j} - {{\sum }_{m = 1}}^{M} {v}_{jm}^{′} {I}_{m} \qquad ( 8 )$$

where Cⱼ denotes the concentration of particles j, Cᵢ′ denotes a concentration of secondary species particles i corresponding to the particles j, νⱼᵢ denotes a stoichiometric number of all particles j and particles i related to liquid phase reactions, Ni denotes a total number of the secondary species particles i, q denotes a groundwater flow velocity, D denotes a molecular diffusion tensor, Qⱼ denotes a source-sink phase of particles j, Im denotes a mineral reaction rate, νⱼₘ′ denotes a stoichiometric number of the particles j related to mineral phase reactions, M denotes a total number of the particles j related to the mineral phase reactions, the particle j denotes a particle with a largest relative concentration in a liquid phase, the secondary species particle i corresponding to particle j denotes a particle of the particle j that is ionized or combined with other groups of the particles in the liquid phase, for example, when the particle j is Ca²⁺, the secondary species particle i corresponding to the particle j includes such as CaCO₃(aq), CaHCO₃⁺, Ca(OH)⁺, CaCl⁺, CaCl_{2(aq)} and CaSO₄(aq), and when the particle j is HCO₃₋, the secondary species particle i corresponding to the particle j includes such as CO₃²⁻, CO_{2(aq)}.
c. A mineral phase reaction rate Im is obtained and calculated by the mass conservation law, specifically,

$${I}_{m} = \frac{1}{{\overline{V}}_{m}} \frac{\partial {φ}_{m}}{\partial t} \qquad ( 9 )$$

where φₘ denotes a mineral volume fraction, V̅ₘ denotes a mineral molar volume.
d. A quantitative relation between the concentration Cⱼ of the particles j of a same type and the concentration Cᵢ′ of the secondary species particles i corresponding to the particles j is obtained according to a mass and energy conservation law of the equilibrium reaction, specifically,

$${C}_{i}^{′} \frac{{γ}_{i}}{{K}_{i}} = {\prod }_{j} {( {γ}_{j} {C}_{j} )}^{{v}_{ji}} \qquad ( 10 )$$

where Kᵢ denotes a reaction equilibrium constant of the secondary species particles i, γⱼ denotes an activity coefficient for the particles j and γᵢ denotes an activity coefficient for the secondary species particles i corresponding to the particles j.

Beneficial effects: in comparison with the prior art, the technical solutions provided by the present disclosure have the following beneficial effects.

A model for transporting a reactive solute in groundwater in a three-dimensional fracture network provided by the present disclosure can consider the influences of the fracture and the fracture rock mass on the transport of the groundwater solute, quantitatively simulate the transport of the solute in the fracture water in large and medium-sized sites, and the relevant hydrogeochemical process, and effectively characterize the spatiotemporal variation rule of the transport of the reactive solute in the groundwater in the three-dimensional fracture network, which provides the key information of the region for monitoring the groundwater pollution, thereby better guiding the on-site works of the transport, the diffusion as well as the prevention and control of the pollutants, in the fracture development region and the subsequent repair and treatments.

### BRIEF DESCRIPTION OF THE DRAWINGS

FIG. 1 illustrates a flow chart of a method for simulating the transport values for the reactive solute in the groundwater in the three-dimensional fracture network.

FIG. 2 illustrates a conceptual model diagram of the transport of the reactive solute in the groundwater in the three-dimensional fracture network.

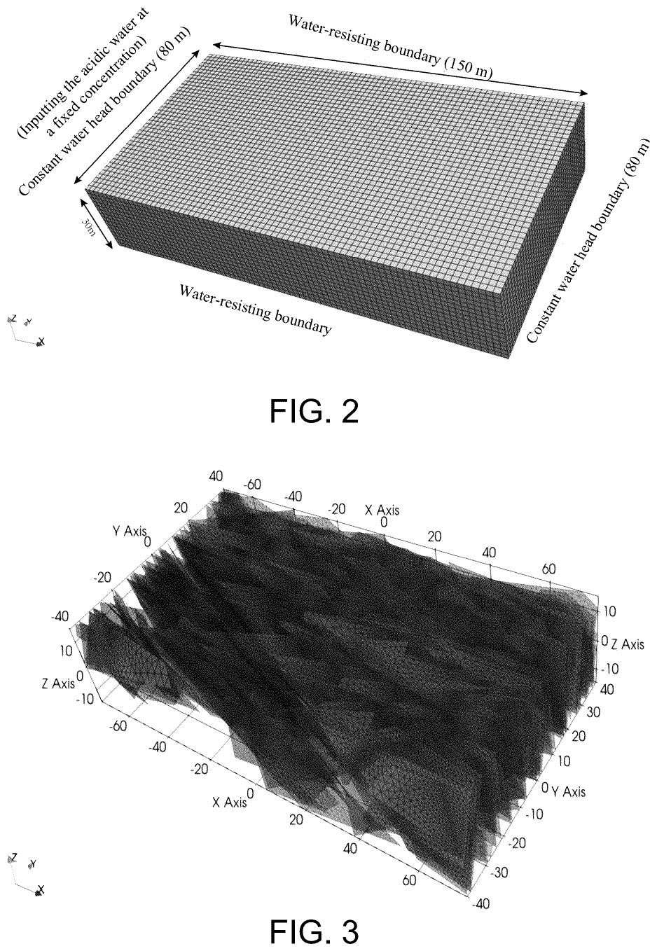

FIG. 3 illustrates a model diagram of the three-dimensional discrete fracture network.

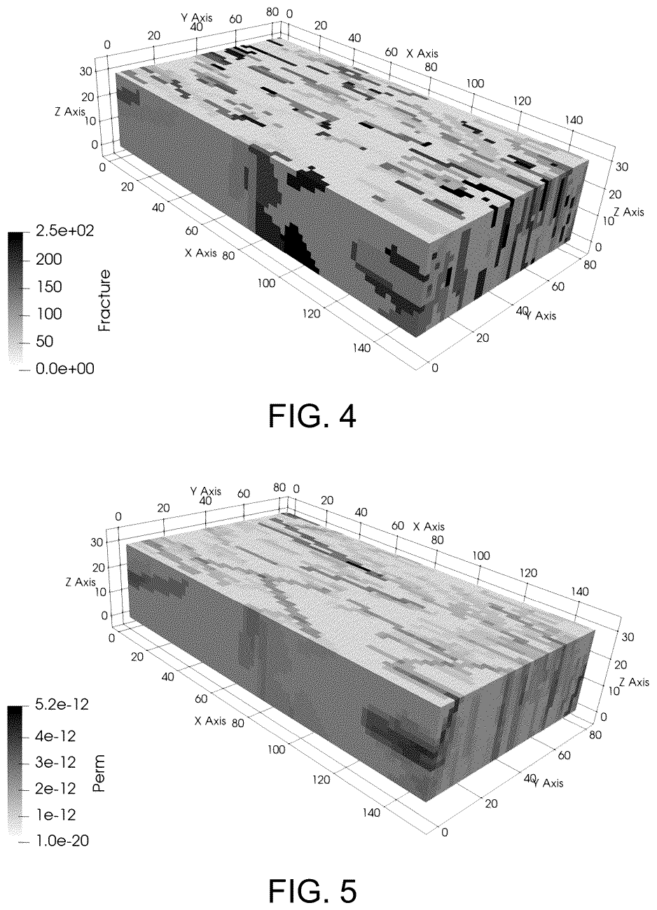

FIG. 4 illustrates a model diagram of the geological structure of the equivalent continuum porous medium in the three-dimensional fracture network.

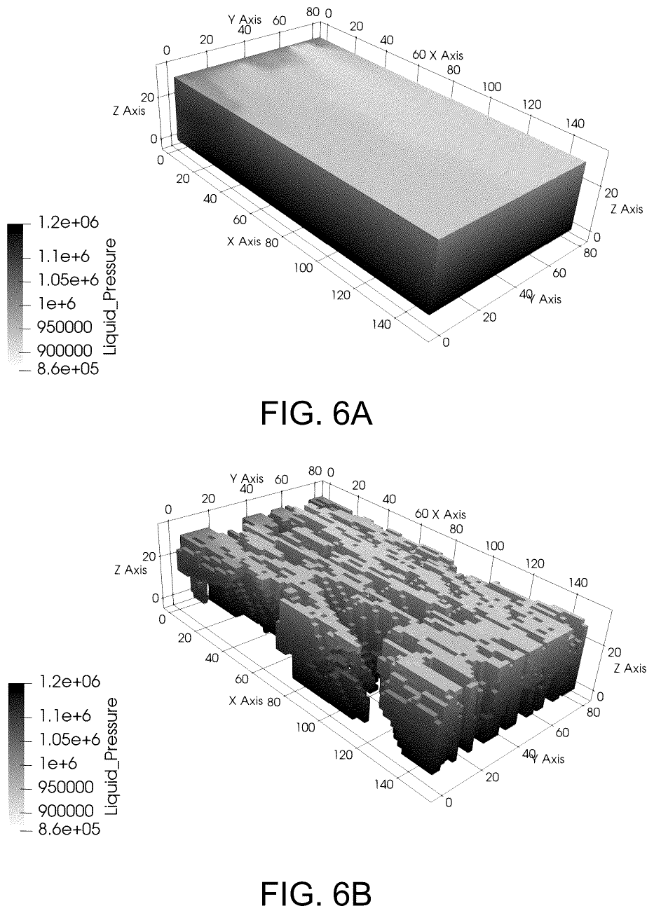

FIG. 5 illustrates a diagram of the spatial distribution of the overall permeability in the three-dimensional fracture network.

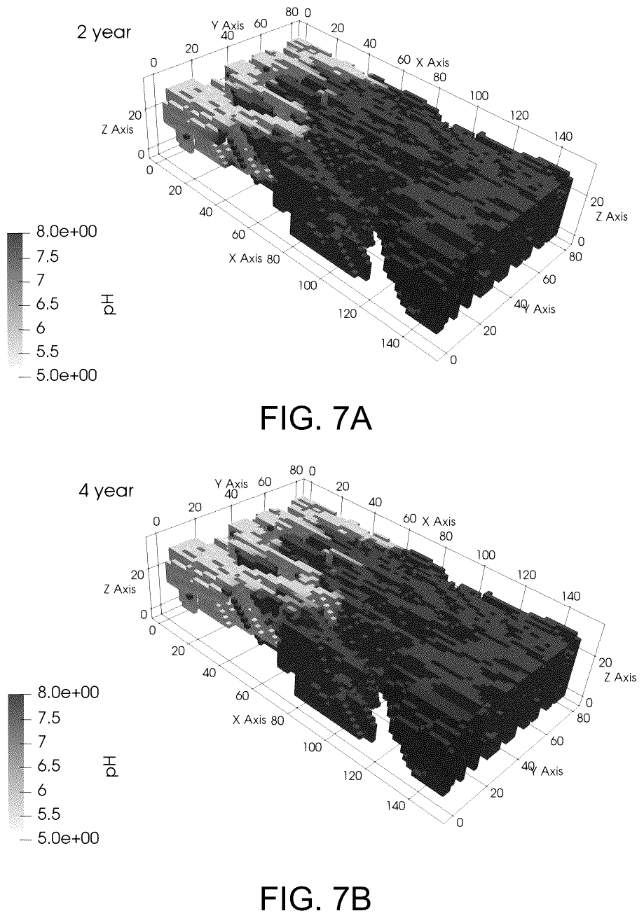

FIG. 6 illustrates a diagram of the spatial distribution of the water pressure field of a whole (a) of the three-dimensional fracture network and the fractures (b) in the three-dimensional fracture network.

FIG. 7 illustrates a diagram of the spatiotemporal distribution of pH in the three-dimensional fracture network.

FIG. 8 illustrates a diagram of the spatial distribution of the simulation of the concentrations of the main components of the groundwater in the three-dimensional fracture network in the 10th year.

### DETAILED DESCRIPTION OF THE INVENTION

The present disclosure will be further described below with reference to the accompanying drawings. The following embodiments are merely utilized to illustrate the technical solutions of the present disclosure more clearly, rather than be utilized to limit the scope of protection of the present disclosure.

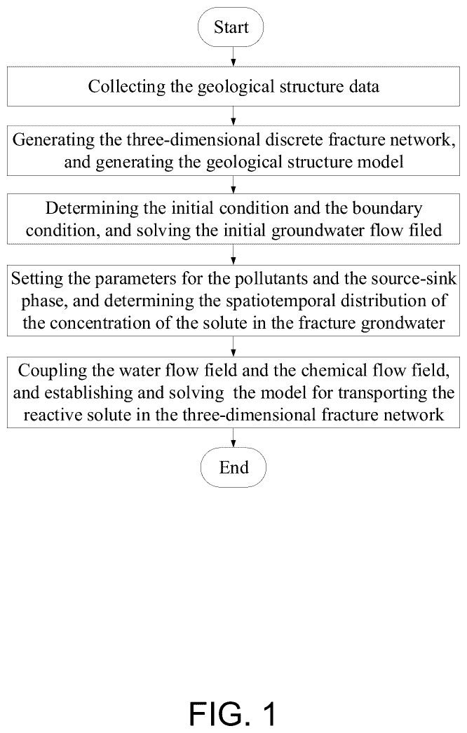

As illustrated in FIG. 1, a method for simulating a transport of a reactive solute in groundwater in a three-dimensional fracture network is proposed by the present disclosure. The method includes the following steps.

In Step SS1, geological structure data of a fracture block in a target research region and the local hydrogeological parameters for the target research region are collected.

In Step SS2, the geological structure data are modeled and parameterized according to the geological structure data collected by Step SS1, lithology parameters for a stratum are set, a discrete fracture network is generated, and a plane fracture grid is upscaled to a three-dimensional cubic grid, the three-dimensional cubic grid is mapped into an equivalent continuum porous medium, then the equivalent continuum porous medium is divided into a three-dimensional fracture body grid to establish a geological structure model for the research region.

In Step SS3, an initial water head condition, a boundary condition, and permeability coefficients for a fracture and a fracture body of the geological structure model are determined based on the geological structure model established by Step SS2, according to the collected hydrogeological parameters, a spatiotemporal distribution of a groundwater level in the research region is solved, and an initial groundwater flow field is obtained.

In Step SS4, physical and chemical parameters for the pollutants and a source-sink phase condition are set based on the initial groundwater flow field obtained by Step SS3, and a spatiotemporal distribution of a solute concentration in the fracture groundwater is determined.

In Step SS5, relevant chemical reaction parameters are set based on a solute transport model obtained by Step SS4, and a water flow field and a chemical flow field are coupled to each other according to a basic equation of a mass and energy conservation, a seepage field equation, and a solute transport control equation, a result for a transport of the reactive solute in the fracture medium driven by a hydrodynamic and a hydrogeochemical reaction is solved, and a simulation of the transport values for the reactive solute in the groundwater in the three-dimensional fracture network is completed.

Further, in Step SS1, the data includes: (1) a hydrogeological condition, a stratum lithology, a stratum thickness, an aquifer buried depth, an aquiclude buried depth, an aquifer thickness, an aquiclude thickness, the spatial distributions of the aquifer and the aquiclude, a recharge-runoff-discharge condition of a hydrogeological unit, a groundwater ion content, groundwater flow rate and velocity, and a hydrogeochemical characteristic; (2) a fracture medium condition, an overall number of the fractures, a spatial distribution of the fractures, a fracture occurrence, an opening degree of the fracture, a fracture development depth, a fracture roughness, physical and chemical properties of a fracture filling and a fracture geological body, and a spatial distribution of the permeability coefficient for the fracture network, in the target research region.

Further, in Step SS2, the three-dimensional fracture network model is established as follows.

Characteristic parameters for the three-dimensional fracture network geological structure model are determined by a discrete fracture network parameter control equation and a model upscaling grid division control equation.
(1) In the discrete fracture network parameter control equation
   a. a direction of a normal vector for a fracture surface is characterized by a von Mises-Fisher distribution function, specifically,

$$\overline{v} = = \frac{κ \cdot {e}^{κ \cdot {\overline{v}}^{T} \cdot I}}{2 π ( {e}^{κ} - {e}^{- κ} )} , \qquad ( 1 )$$

where ν̅ denotes a matrix of a mean normal vector for the fracture, k denotes a density coefficient, T denotes a matrix transpose, and I denotes an identity matrix;
b. a truncated power law distribution is adopted by a fracture radius R, and the fracture radius R is defined by the following probability density function,

$$R = {( \frac{α}{{R}_{1}^{- α} - {R}_{u}^{- α}} )}^{- 2 - α} \qquad ( 2 )$$

where Rᵤ denotes an upper boundary of the fracture radius, Rₗ denotes a lower boundary of the boundary radius, and a denotes a constant coefficient;
c. a fracture opening degree φ is determined by an exponential function of the fracture radius, specifically,

$$ϕ = F \cdot {R}^{γ} \qquad ( 3 )$$

where both F and γ denote the parameter values related to the water permeability.
d. a fracture permeability k is calculated based on the fracture opening degree, specifically,

$$k = \frac{{ϕ}^{2}}{12} \qquad ( 4 )$$

(2) In the model upscaling grid division control equation,
   a. a fracture medium porosity n is calculated based on an opening degrees of the fracture passing through each grid, specifically,

$$n = \frac{1}{l} {{\sum }_{i = 1}}^{N} {ϕ}_{i} \qquad ( 5 )$$

where l denotes a side length of a divided grid, N denotes a total number of the fractures passing through the divided grid, φᵢ denotes an opening degree of an i-th fracture in a target grid and is calculated by Formula (3);
b. a fracture medium permeability k_{f} is assigned with reference to a permeability of each fracture in the grid, specifically,

$${k}_{f} = {\sum }_{i = 1}^{N} {k}_{i} \qquad ( 6 )$$

where kᵢ denotes a permeability of the i-th fracture in the target grid and is calculated by formula (4).

Further, in Step SS4, the set parameters for the pollutants include a groundwater background ion component, a groundwater background ion concentration, a pollution source ion component, a pollution source ion concentration, and a condition of a boundary of a source-sink phase. In Step SS5, the chemical reaction parameters include a reaction equation of a groundwater ion component, an reaction equilibrium constant of the groundwater ion component, a mineral component, a mineral volume fraction, the mineral reaction rate constant, and a mineral phase specific surface area.

Further, in Step SS5, the groundwater reactive solute transport model is constructed as follows.

A spatiotemporal evolution law of a target pollutants in the model driven by the hydrodynamic and the hydrogeochemical action is calculated and obtained by the seepage field equation, the solute transport control equation, and the mass and energy conservation equation.
a. The seepage field equation is:

$$\frac{\partial }{\partial t} ( nsp ) - ∇ ( ρ \frac{{kk}_{r}}{μ} ∇ ( P - ρ gz ) ) = w , \qquad ( 7 )$$

where n denotes a porosity, s denotes a saturation, ρ denotes a fluid density, w denotes an infiltration supply volume, k denotes an absolute permeability, kᵣ denotes a relative permeability, μ denotes a fluid viscosity coefficient, P denotes a pressure, g denotes a gravity acceleration and z denotes an elevation water head.
b. The solute transport control equation is derived according to a mass conservation law of mass and is represented as follows:

$$\frac{\partial ( n ( {C}_{j} + {\sum }_{i = 1}^{{N}_{i}} {υ}_{ji} {C}_{i}^{′} ) )}{\partial t} + ∇ ( q - nsD ∇ ) ( {C}_{j} + {\sum }_{i = 1}^{{N}_{i}} {υ}_{ji} {C}_{i}^{′} ) = {Q}_{j} - {\sum }_{m = 1}^{M} {υ}_{jm}^{′} {I}_{m} \qquad ( 8 )$$

where Cⱼ denotes a concentration of particles j, Cᵢ′ denotes a concentration of secondary species particles i corresponding to the particles j, νⱼᵢ denotes a stoichiometric number of all particles j and particles i related to liquid phase reactions, Nᵢ denotes a total number of the secondary species particles i, q denotes a groundwater flow velocity, D denotes a molecular diffusion tensor, Qⱼ denotes a source-sink phase of the particles j, Iₘ denotes a mineral reaction rate, νⱼₘ′ denotes a stoichiometric number of the particles j related to mineral phase reactions, M denotes a total number of the particles j related to the mineral phase reactions, the particle j denotes a particle with a largest relative concentration in a liquid phase, the secondary species particle i corresponding to particle j denotes a particle of the particle j that is ionized or combined with other groups of the particles in the liquid phase, for example, when the particle j is Ca²⁺, the secondary species particle i corresponding to the particle j includes such as CaCO₃(aq), CaHCO₃⁺, Ca(OH)⁺, CaCl⁺, CaCl_{2(aq)} and CaSO₄(aq), and when the particle j is HCO₃⁻, the secondary species particle i corresponding to the particle j includes such as CO₃²⁻, CO_{2(aq)}.
c. A mineral phase reaction rate Im is obtained and calculated by the mass conservation law, specifically,

$${I}_{m} = \frac{1}{{\overline{V}}_{m}} \frac{\partial {φ}_{m}}{\partial t} \qquad ( 9 )$$

where φₘ denotes a mineral volume fraction, V̅ₘ denotes a mineral molar volume.
d. A quantitative relation between the concentration Cⱼ of the particles j of a same type and the concentration Cᵢ′ of the secondary species particles i corresponding to the particles j is obtained according to a mass and energy conservation law of an equilibrium reaction, specifically,

$${C}_{i}^{′} \frac{{γ}_{i}}{{K}_{i}} = {\prod }_{j} {( {γ}_{j} {C}_{j} )}^{{υ}_{jt}} \qquad ( 10 )$$

where Kᵢ denotes a reaction equilibrium constant of the secondary species particles i, γⱼ denotes an activity coefficient for the particles j and γᵢ denotes an activity coefficient for the secondary species particles i corresponding to the particles j.

A system for simulating a transport of a reactive solute in the groundwater in a three-dimensional fracture network is further provided by the present disclosure. The system includes a model parameter collection module, a three-dimensional fracture network construction module, a groundwater flow module, a solute transport module and a fracture reaction transport module.

The model parameter collection module is configured to collect the geological structure data of a fracture block in a target research region and local hydrogeological parameters for the target research region.

The three-dimensional fracture network construction module is configured to model and parameterize the geological structure data according to the collected geological structure data, set lithology parameters for a stratum, generate a discrete fracture network, and upscale a plane fracture grid to a three-dimensional cubic grid and map the three-dimensional cubic grid into an equivalent continuum porous medium and divide the equivalent continuum porous medium into a three-dimensional fracture body grid to establish the geological structure model for the research region.

The groundwater flow module is configured to determine an initial water head condition, a boundary condition, permeability coefficients for a fracture and a fracture body of the geological structure model based on the established geological structure model according to the collected hydrogeological parameters, and a spatiotemporal distribution of a groundwater level in the research region is solved, and an initial groundwater flow field is obtained.

The solute transport module is configured to set physical and chemical parameters for pollutants and a source-sink phase condition based on the obtained initial groundwater flow field, and determine a spatiotemporal distribution of a solute concentration in fracture groundwater.

The fracture reaction transport module is configured to set relevant chemical reaction parameters based on the solute transport model, and couple a water flow field and a chemical flow field according to a basic equation of a mass and energy conservation, a seepage field equation, and a solute transport control equation, solve a result for the transport of the reactive solute in a fracture medium driven by a hydrodynamic and a hydrogeochemical reaction, and complete a simulation of transport values for the reactive solute in the groundwater in the three-dimensional fracture network.

Further, the data includes (1) a hydrogeological condition, a stratum lithology, a stratum thickness, an aquifer buried depth, an aquiclude buried depth, an aquifer thickness, an aquiclude thickness, the spatial distributions of the aquifer and the aquiclude, a recharge-runoff-discharge condition of a hydrogeological unit, a groundwater ion content, groundwater flow rate and velocity, and a hydrogeochemical characteristic; (2) a fracture medium condition, an overall number of the fractures, a spatial distribution of the fractures, a fracture occurrence, a fracture opening degree, a fracture development depth, a fracture roughness, the physical and chemical properties of a fracture filling and a fracture geological body, and a spatial distribution of the permeability coefficients for a fracture network, in the target research region.

Further, the three-dimensional fracture network model is constructed as follows.

Characteristic parameters for the three-dimensional fracture network geological structure model are determined by a discrete fracture network parameter control equation and a model upscaling grid division control equation.
(1) In the discrete fracture network parameter control equation,
   a. a direction of a normal vector for a fracture surface is characterized by a von Mises-Fisher distribution function, specifically,

$$\overline{v} = \frac{κ \cdot {e}^{κ \cdot {\overline{ν}}^{T} \cdot I}}{2 π ( {e}^{κ} - {e}^{- κ} )} , \qquad ( 1 )$$

where ν̅ denotes a matrix of a mean normal vector for the fracture, k denotes a density coefficient, T denotes a matrix transpose, and I denotes an identity matrix.
b. a truncated power law distribution is adopted by a fracture radius R, and the fracture radius R is defined by a following probability density function,

$$R = {( \frac{α}{{R}_{l}^{- α} - {R}_{u}^{- α}} )}^{- 2 - α} \qquad ( 2 )$$

where Rᵤ denotes an upper boundary of the fracture radius, Rₗ denotes a lower boundary of the fracture radius, and a denotes a constant coefficient.
c. a fracture opening degree φ is determined by an exponential function of the fracture radius,

$$Φ = F \cdot {R}^{γ} \qquad ( 3 )$$

where both F and γ denote the parameter values related to a water permeability.
d. a fracture permeability k is calculated based on the fracture opening degree φ, specifically,

$$k = \frac{{Φ}^{2}}{12} . \qquad ( 4 )$$

(2) In the model upscale grid division control equation,
   a. a fractured medium porosity n is calculated based on an opening degrees of the fractures passing through each grid, specifically,

$$n = \frac{1}{l} {\sum }_{i = 1}^{N} {Φ}_{i} \qquad ( 5 )$$

where l denotes a side length of a divided grid, N denotes a total number of the fractures passing through the divided grid, and φᵢ denotes an opening degree of an i-th fracture in a target grid and is calculated by Formula (3);
b. the fracture medium permeability k_{f} is assigned with reference to a permeability of each fracture in the grid, specifically,

$${k}_{f} = {\sum }_{i = 1}^{N} {k}_{i} \qquad ( 6 )$$

where kᵢ denotes a permeability of the i-th fracture in the target grid and is calculated by Formula (4).

Further, the set parameters for the pollutants include the groundwater background ion component, a groundwater background ion concentration, a pollution source ion component, a pollution source ion concentration, and a condition of a boundary of a source-sink phase. In Step SS5, the chemical reaction parameters include an reaction equation of a groundwater ion component, a reaction equilibrium constant of the groundwater ion component, a mineral component, a mineral volume fraction, a mineral reaction rate constant, and a mineral phase specific surface area.

Further, the groundwater reactive solute transport model is constructed as follow.

A spatiotemporal evolution law of the target pollutants in the model driven by the hydrodynamic and the hydrogeochemical action is calculated and obtained by the seepage field equation, the solute transport control equation, and the mass and energy conservation equation.
a. The seepage field equation is as follows:

$$\frac{\partial }{\partial t} ( nsp ) - ∇ ( ρ \frac{{kk}_{r}}{μ} ∇ ( P - ρ gz ) ) = w \qquad ( 7 )$$

where n denotes a porosity, s denotes a saturation, ρ denotes a fluid density, w denotes an infiltration supply volume, k denotes an absolute permeability, kᵣ denotes a relative permeability, μ denotes a fluid viscosity coefficient, P denotes a pressure, g denotes a gravity acceleration and z denotes an elevation water head.
b. The solute transport control equation is derived according to a mass conservation law and is represented as follows:

$$\frac{\partial ( n ( {C}_{j} + {\sum }_{i = 1}^{{N}_{i}} {υ}_{ji} {C}_{i}^{′} ) )}{\partial t} + ∇ ( q - nsD ∇ ) ( {C}_{j} + {\sum }_{i = 1}^{{N}_{i}} {υ}_{ji} {C}_{i}^{′} ) = {Q}_{j} - {\sum }_{m = 1}^{M} {υ}_{jm}^{′} {I}_{m} , \qquad ( 8 )$$

where Cⱼ denotes the concentration of particles j, Cᵢ [symbol] denotes a concentration of secondary species particles i corresponding to the particles j, νⱼᵢ denotes a stoichiometric number of all particles j and particles i related to liquid phase reactions, Ni denotes a total number of the secondary species particles i, q denotes a groundwater flow velocity, D denotes a molecular diffusion tensor, Qⱼ denotes a source-sink phase of particles j, Iₘ denotes a mineral reaction rate, νⱼₘ [symbol] denotes a stoichiometric number of the particles j related to mineral phase reactions, M denotes a total number of the particles j related to the mineral phase relations, the particle j denotes a particle with a largest relative concentration in a liquid phase, the secondary species particle i corresponding to the particle j denotes a particle of the particle j that is ionized or combined with other groups of the particles in the liquid phase, for example, when the particle j is Ca²⁺, the secondary species particle i corresponding to the the particle j includes such as CaCO₃(aq), CaHCO₃⁺, Ca(OH)⁺, CaCl⁺, CaCl_{2(aq)} and CaSO₄(aq), and when the particle j is HCO₃⁻, the secondary species particle i corresponding to the particle j includes such as CO₃²⁻, CO₂(aq).
c. A mineral phase reaction rate Im is obtained and calculated by the mass conservation law, specifically,

$${I}_{m} = \frac{1}{{\overline{V}}_{m}} \frac{\partial {φ}_{m}}{\partial t} \qquad ( 9 )$$

where φₘ denotes a mineral volume fraction, V̅ₘ denotes a mineral molar volume.
d. A quantitative relation between the concentration Cⱼ of the particles j of the same type and the concentration Cᵢ′ of the secondary species particles i corresponding to the particles j is obtained according to a mass and energy conservation law of the equilibrium reaction, specifically,

$${C}_{i}^{′} \frac{{γ}_{i}}{{K}_{i}} = {\prod }_{j} {( {γ}_{j} {C}_{j} )}^{{υ}_{ji}} \qquad ( 10 )$$

where Kᵢ denotes a reaction equilibrium constant of the secondary species particles i, γⱼ denotes an activity coefficient for the particles j and γᵢ denotes an activity coefficient for the secondary species particles i corresponding to the particles j.

Embodiment 1: the established benchmark model is taken as an example in this embodiment of the present disclosure.

### 1) Concept Model

The simulation region of this example is a rectangle with a length of 150 m and a width of 80 m, and the aquifer thickness is 30 m. In the simulation region, the three-dimensional discrete fracture network is generated, the fracture statistical characteristic is set as the truncated power law distribution, the fracture length is limited in a range from 10 m to 40 m, the value for the fracture density parameter P₃₂ is set to 1.1 (that is, the sum of all fracture areas per unit volume is 1.1 m²), the main fracture group has a direction of 90° and an inclined angle of 90°. A total of 253 connected effective fractures are generated in the discrete fracture network model, which are mapped into the equivalent continuum porous medium model, and divided into 75 rows×40 columns×15 layers, with a total of 45,000 effective units. The water flow direction in the simulation region is from west to east, the east and west boundaries are set as the constant water head boundaries, the difference between the water heads located at the west and the east is 0.03 m, the south and north boundaries are set as the zero flow boundaries, and the aquifer floor is the water-resisting boundary. The rainfall infiltration and the water evaporation are not considered in the simulation region. The rock mass matrix of the model is the homogeneous and isotropic aquifer medium, and the permeability is set to 1.0×10⁻²⁰, the porosity is set to 5.0×10⁻³, the tortuosity is set to 0.2, the longitudinal dispersivity is 1 m, the transverse dispersivity is 0.001 m, and the vertical dispersivity is 0.001 m. The parameters for the fracture part are set as the equivalent continuum porous medium with the heterogeneous anisotropy according to the physical properties of the discrete fracture network such as the shape size, the opening degree and the roughness.

The simulation region is initially buffered and balanced by the slightly alkaline water (pH=8) and the limestone matrix, and then the acidic water (pH=5) is flowed to the simulation region at a fixed concentration from the west. The main mineral of the rock mass in the whole three-dimensional fracture model is calcite, and the initial volume fraction is 1.0×10⁻⁵. The initial concentrations of the main ions in the acidic water and the model groundwater are illustrated in Table 1, and the parameters for the related main reaction in the model are illustrated in Table 2. The dissolution reaction rate constant for the calcite in the fracture rock mass is 1.0×10⁻⁶ mol/m²s, and the specific surface area for the calcite in the fracture rock mass is 1.0 m²/m³, and the total stress period of the simulation is set to 10 years.

TABLE 1
Parameters for main ions in the model in the
embodiments of the present disclosure (unit: mol/L)

| | Initial | Acidic water |
|---|---|---|
| Component | concentration | concentration |
| H⁺ | 1.0 × 10⁻⁸ | 1.0 × 10⁻⁵ |
| Ca²⁺ | 5.2 × 10⁻⁴ | 1.0 × 10⁻⁶ |
| HCO₃⁻ | 1.7 × 10⁻³ | 1.0 × 10⁻³ |

TABLE 2
Parameters for main reactions in the model in
the embodiments of the present disclosure

| | Equilibrium |
|---|---|
| | constant |
| Reaction equation | log₁₀K (25°) |
| OH⁻ + H⁺ ↔ H₂O | 14.00 |
| H⁺ + CO₃²⁻ ↔ HCO₃⁻ | 10.33 |
| H⁺ + HCO₃⁻ ↔ CO₂(aq) + H₂O | 6.34 |
| CaCO₃ + H⁺ ↔ Ca²⁺ + HCO₃⁻ | 1.85 |

### 2) Determination of the Control Equations

(1) in the discrete fracture network parameter control equation,
   a. the direction of the normal vector for the fracture surface is characterized by the von Mises-Fisher distribution function, specifically,

$$\overline{v} == \frac{κ \cdot {e}^{κ \cdot {\overline{v}}^{T} \cdot I}}{2 π ( {e}^{κ} - {e}^{- κ} )} \qquad ( 1 )$$

where ν̅ denotes the matrix of the mean normal vector for the fracture, κ denotes the density coefficient, T denotes the matrix transpose, and I denotes the identity matrix.
b. the truncated power law distribution is adopted by the fracture radius R, and the fracture radius R is defined by the following probability density function,

$$R = {( \frac{α}{{R}_{l}^{- α} - {R}_{u}^{- α}} )}^{- 2 - α} \qquad ( 2 )$$

where Rᵤ denotes the upper boundary of the fracture radius, Rₗ denotes the lower boundary of the fracture radius, and α denotes the constant coefficient;
c. the fracture opening degree φ is determined by the exponential function of the fracture radius, specifically,

$$Φ = F \cdot {R}^{γ} \qquad ( 3 )$$

where both F and γ denote the parameter values related to the water permeability.
d. the fracture permeability k is calculated based on the fracture opening degree φ, specifically,

$$k = \frac{{ϕ}^{2}}{12} , \qquad ( 4 )$$

(2) In the model upscale grid division control equation,
   a. the fracture medium porosity n is calculated based on the opening degree of the fractures passing through each grid, specifically,

$$n = \frac{1}{l} {\sum }_{i = 1}^{N} {ϕ}_{i} \qquad ( 5 )$$

where l denotes a side length of a divided grid, N denotes a total number of the fractures passing through the divided grid, and φᵢ denotes an opening degree of an i-th fracture in the target grid (φᵢ is calculated by Formula (3));
b. the fracture medium permeability k_{f} is assigned with reference to a permeability of each fracture in the grid, specifically,

$${k}_{f} = {\sum }_{i = 1}^{N} {k}_{i} \qquad ( 6 )$$

where kᵢ denotes the permeability of the i-th fracture in the target grid (kᵢ is calculated by Formula (4)).
(3) The control equation of the groundwater reactive solute transport model
a. The seepage field equation is as follows:

$$\frac{\partial }{\partial t} ( n s ρ ) - ∇ ( ρ \frac{k {k}_{r}}{μ} ∇ ( P - ρ g z ) ) = w , \qquad ( 7 )$$

where n denotes the porosity, s denotes the saturation, ρ denotes the fluid density, w denotes the infiltration supply volume, k denotes the absolute permeability, kᵣ denotes the relative permeability, μ denotes the fluid viscosity coefficient, P denotes the pressure, g denotes the gravity acceleration and z denotes the elevation water head.
b. The solute transport control equation is derived according to the mass conservation law and is represented as follows:

$$\frac{\partial ( n ( {C}_{j} + {\sum }_{i = 1}^{{N}_{i}} {υ}_{j i} {C}_{i}^{′} ) )}{\partial t i} + ∇ ( q - n s D ∇ ) ( {C}_{j} + {\sum }_{i = 1}^{{N}_{t}} {υ}_{j i} {C}_{i}^{′} ) = {Q}_{j} - {\sum }_{m = 1}^{M} {υ}_{j m}^{′} {I}_{m} \qquad ( 8 )$$

where Cⱼ denotes the concentration of particles j, Cᵢ′ denotes the concentration of the secondary species particles i corresponding to particles j, νⱼᵢ denotes the stoichiometric number of all particles j and particles i related to the liquid phase reactions, Nᵢ denotes the total number of the secondary species particles i, q denotes the groundwater flow velocity, D denotes the molecular diffusion tensor, Qⱼ denotes the source-sink phase of particles j, Iₘ denotes the mineral reaction rate, νⱼₘ′ denotes the stoichiometric number of particles j related to the mineral phase reaction, M denotes the total number of particles j related to the the mineral phase, particle j denotes the particles with the largest relative concentration in the liquid phase, the secondary species particle i corresponding to particle j denotes a particle of the particle j that is ionized or combined with other groups of the particles in the liquid phase, for example, when particle j is Ca²⁺, the secondary species particle i corresponding to particle j includes such as CaCO_{3(aq)}, CaHCO₃⁺, Ca(OH)⁺, CaCl⁺, CaCl²(aq) and CaSO₄(aq), and when the particle j is HCO₃⁻, the secondary species particle i corresponding to the particle j includes such as CO₃²⁻, CO₂(aq).
c. The mineral phase reaction rate Im is obtained and calculated by the mass conservation law, specifically,

$${I}_{m} = \frac{1}{{\overline{V}}_{m}} \frac{\partial {φ}_{m}}{\partial t} \qquad ( 9 )$$

where φₘ denotes the mineral volume fraction, V̅ₘ denotes the mineral molar volume.
d. The quantitative relationship between the concentration Cⱼ of particles j of the same type and the concentration Cᵢ′ of the secondary species particle i corresponding to the particle j is obtained according to the mass and energy conservation law of the equilibrium reaction, specifically,

$${C}_{i}^{′} \frac{{γ}_{i}}{{K}_{i}} = {\prod }_{j} {( {γ}_{j} {C}_{j} )}^{{υ}_{ji}} \qquad ( 10 )$$

where Kᵢ denotes an reaction equilibrium constant of the secondary species particle i, γⱼ denotes an activity coefficient for the particle j and γᵢ denotes an activity coefficient for the secondary species particle i corresponding to particle j.
3) Analysis on the result for the numerical simulation of the model for transporting the reactive solute in the groundwater in three-dimensional fracture network.

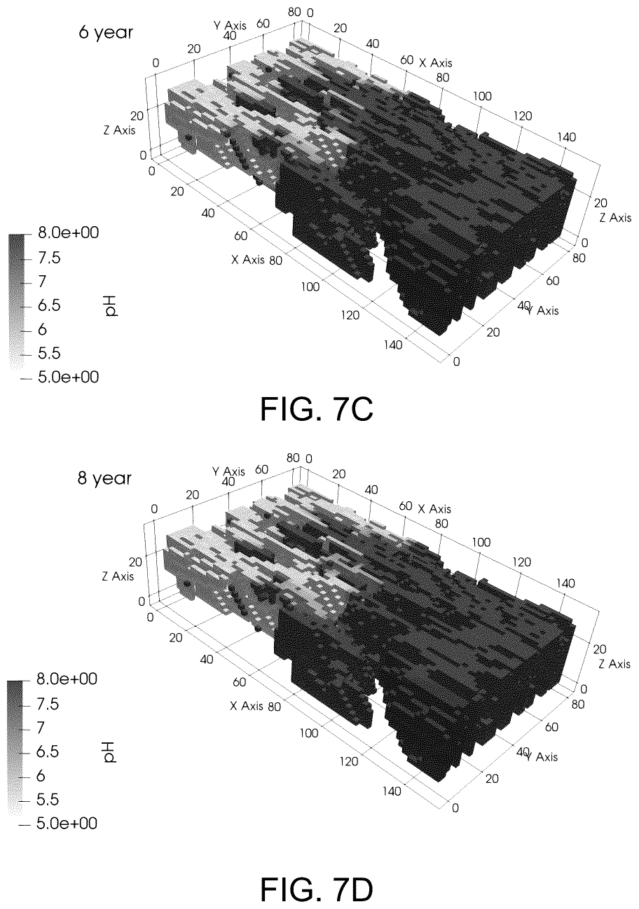

The distribution of the pressure field of the groundwater in the fracture network is illustrated in FIG. 6. It can be seen that the groundwater flow field in the shallow underground depth is affected by the distribution of the fractures, so that the distribution of the water pressure field in the upstream area has the significant non-uniformity. However, this influence is gradually decreased with the increase of the depth, which indicates that the spatial distribution of the water gradient in the fracture in deep layer is similar to that of the groundwater in the saturated porous medium.

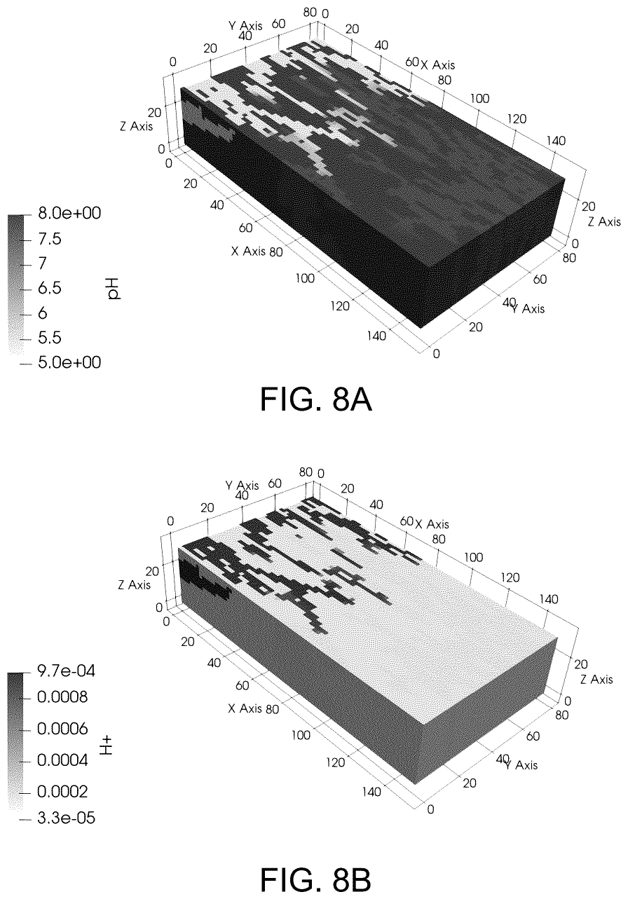

The spatiotemporal distribution rule of the pH values in the fracture network in the first eight years under a simulated scenario of the continuous leakage of the acidic water at a certain concentration is illustrated in FIG. 7. By comparing the simulated pH distribution of the fracture groundwater in the 2^{nd} year with the simulated pH distribution of the fracture groundwater in the 4^{th}, 6^{th} and 8^{th}, it can be seen that when the acid water is entered the fracture groundwater for a short time, the transport and diffusion efficiency is the highest, while, after the second year, when the transport distance of the acid water is increased, the transport rate is gradually decreased. The reason may be that as the acidic water is continued to transport in the fracture medium, the contact area between the acidic water and the limestone in the fracture groundwater is permanently increased, the buffering effect of the fracture rock mass on the acidic water is continued to be increased, which effectively blocks the transport process of the acidic water. In addition, it can be seen from the figure that the obvious preferential flow of the acidic water is generated in the longitudinally staggered and dense region of the fractures, which is due to the accumulation of the water-conducting fractures along the direction of the descent of the hydraulic gradient, resulting in a corresponding increase in permeability in this part. The rules reflected by the above are consistent with the laws of the reality, which further indirectly demonstrates that the model is scientific in characterizing the transport of the reactive solute in the three-dimensional fracture groundwater.

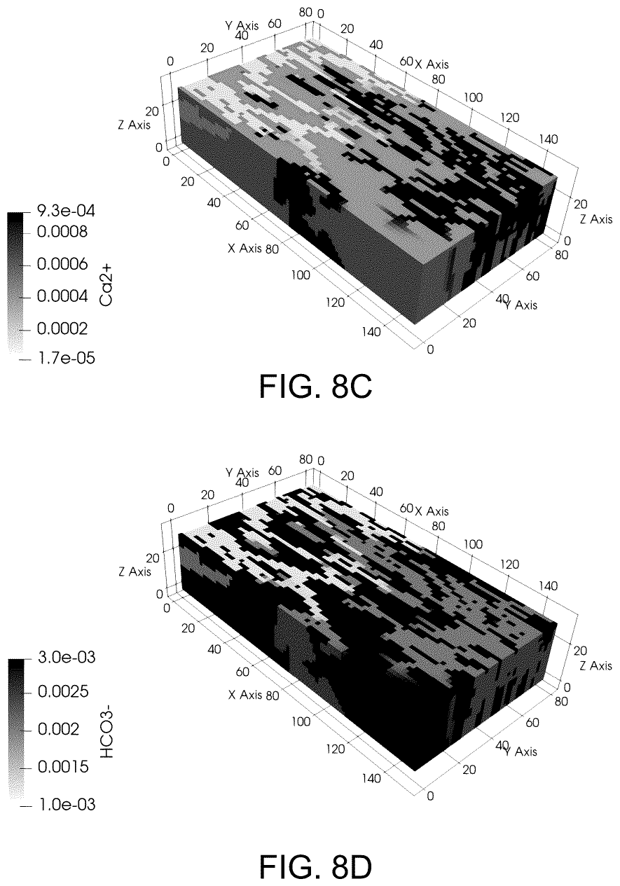

The simulation of the spatial distribution of the concentration of the main components of the groundwater in the three-dimensional fracture network in the 10^{th} year is illustrated in FIG. 8. It can be seen from the figure that the maximum value for the distance range affected by the acidic water is 92 m, which is mainly concentrated in the fracture medium. In addition, as the acidic water is continued to transport downstream, the calcite is continuously buffered and dissolved, so that a large-scale Ca²⁺ plume are generated behind the acidic frontal surface. The native high-concentration HCO₃⁻ are also participated in the buffering, the HCO₃⁻ in the acidic area is reacted while the HCO₃⁻ is permanently displaced by the HCO₃⁻ with a low concentration in the acidic water, which results in a decrease in the overall HCO₃⁻ free ion concentration in the groundwater in the fracture medium. In comparison with FIG. 7, it can be seen that the solute transport of the free ions in the fracture groundwater in the simulation region is mainly located in the fracture medium area with a high hydraulic conductivity. However, the chemical components in the rock mass matrix are remained basically unvaried, except a minor various at the fracture medium contact surface, which has a significant impact on the hydrogeochemical reaction in the overall fracture groundwater, which is also a link that cannot be ignored in guiding the repair and the treatment of the fracture groundwater.

The above are merely the preferred embodiments of the present disclosure. It should be noted that those of ordinary skill in the art can also make several improvements and modifications without departing from the technical principles of the present disclosure. These improvements and modifications should also be regarded as the protection scope of the present disclosure.

1. A method for simulating a transport of a reactive solute in groundwater in a three-dimensional fracture network, wherein the method comprises following steps:
Step SS1, collecting geological structure data of a fracture block in a target research region and local hydrogeological parameters for the target research region;
Step SS2, modeling and parameterizing, according to the geological structure data collected by Step SS1, the geological structure data; setting lithology parameters for a stratum, generating a discrete fracture network; upscaling a plane fracture grid to a three-dimensional cubic grid and mapping the three-dimensional cubic grid into an equivalent continuum porous medium; then dividing the equivalent continuum porous medium into a three-dimensional fracture body grid to establish a geological structure model for a research region;
Step SS3, determining, based on the geological structure model established by Step SS2, an initial water head condition, a boundary condition, and permeability coefficients for fractures and a fracture body of the geological structure model according to collected hydrogeological parameters; solving a spatiotemporal distribution of a groundwater level in the research region, and obtaining an initial groundwater flow field;
Step SS4, setting, based on the initial groundwater flow field obtained by Step SS3, physical and chemical parameters for pollutants and a source-sink phase condition; and determining a spatiotemporal distribution of a solute concentration in fracture groundwater; and
Step SS5, setting, based on a solute transport model obtained by Step SS4, relevant chemical reaction parameters; coupling, according to a basic equation of a mass and energy conversion, a seepage field equation and a solute transport control equation, a water flow field and a chemical flow to each other; solving a result for the transport of the reactive solute in a fracture medium driven by a hydrodynamic and a hydrogeochemical reaction; and completing a simulation of transport values for the reactive solute in the groundwater in the three-dimensional fracture network.

2. The method for simulating the transport of the reactive solute in the groundwater in the three-dimensional fracture network according to claim 1, wherein in Step SS1, data include (1) a hydrogeological condition, a stratum lithology, a stratum thickness, an aquifer buried depth, an aquiclude buried depth, an aquifer thickness, an aquiclude thickness, spatial distributions of an aquifer and an aquiclude, a recharge-runoff-discharge condition of a hydrogeological unit, a groundwater ion content, groundwater flow rate and velocity, and a hydrogeochemical characteristic; (2) a fracture medium condition, an overall number of the fractures, a spatial distribution of the fractures, a fracture occurrence, an opening degree of the fractures, a fracture development depth, a fracture roughness, physical and chemical properties of a fracture filling and a fracture geological body, and a spatial distribution of permeability coefficients for a fracture network, in the target research region.

3. The method for simulating the transport of the reactive solute in the groundwater in the three-dimensional fracture network according to claim 1, characterized in that, wherein in Step SS2, a three-dimensional fracture network model is constructed that,
characteristic parameters for a three-dimensional fracture network geological structure model are determined by a discrete fracture network parameter control equation and a model upscaling grid division control equation, specifically,
(1) in the discrete fracture network parameter control equation,
a, a direction of a normal vector for a fracture surface is characterized by a von Mises-Fisher distribution function, specifically,
$$\overline{v} == \frac{κ \cdot {e}^{κ \cdot {\overline{v}}^{T} \cdot I}}{2 π ( {e}^{κ} - {e}^{- κ} )} \qquad ( 1 )$$
where ν̅ denotes a matrix of a mean normal vector for the fractures, κ denotes a density coefficient, T denotes a matrix transpose, and I denotes an identity matrix;
b, a truncated power law distribution is adopted by a fracture radius R, and the fracture radius R is defined by a following probability density function,
$$R = {( \frac{α}{{R}_{1}^{- α} - {R}_{u}^{- α}} )}^{- 2 - α} \qquad ( 2 )$$
where Rᵤ denotes an upper boundary of the fracture radius, Rₗ denotes a lower boundary of the fracture radius, and a denotes a constant coefficient;
c, a fracture opening degree φ is determined by an exponential function of the fracture radius, specifically,
$$ϕ = F \cdot {R}^{γ} \qquad ( 3 )$$
where both F and γ denote parameter values related to a water permeability; and
d, a fracture permeability k is calculated based on the fracture opening degree φ, specifically,
$$k = \frac{{ϕ}^{2}}{12} \qquad ( 4 )$$
(2) in the model upscaling grid division control equation,
a, a fracture medium porosity n is calculated based on an opening degree of the fracture passing through each grid, specifically,
$$n = \frac{1}{l} {\sum }_{i = 1}^{N} {ϕ}_{i} \qquad ( 5 )$$
where l denotes a side length of a divided grid, N denotes a total number of the fractures passing through the divided grid, and φᵢ denotes an opening degree of an i-th fracture in a target grid and is calculated by Formula (3); and
b, a fracture medium permeability k_{f} is assigned with reference to a permeability of each of the fractures in the grid, specifically,
$${k}_{f} = {\sum }_{i = 1}^{N} {k}_{i} \qquad ( 6 )$$
where kᵢ denotes a permeability of the i-th fracture in the target grid and is calculated by Formula (4).

4. The method for simulating the transport of the reactive solute in the groundwater in the three-dimensional fracture network according to claim 1, wherein in Step SS4, the set parameters for the pollutants include a groundwater background ion component, a groundwater background ion concentration, a pollution source ion component, a pollution source ion concentration and a condition of a boundary of a source-sink phase; and in Step SS5, the chemical reaction parameters include a reaction equation of a groundwater ion component and a reaction equilibrium constant of the groundwater ion component, a mineral component, a mineral volume fraction, a mineral reaction rate constant, and a mineral phase reaction specific surface area.

5. The method for simulating the transport of the reactive solute in the groundwater in the three-dimensional fracture network according to claim 1, wherein in Step SS5, a groundwater reactive solute transport model is constructed that,
a spatiotemporal evolution law of a target pollution in the model driven by the hydrodynamic and the hydrogeochemical action is calculated and obtained by seepage field equation, the solute transport control equation, and the mass and energy conversion equation, specifically,
a, the seepage field equation is
$$\frac{\partial }{\partial t} ( n s ρ ) - ∇ ( ρ \frac{k {k}_{r}}{μ} ∇ ( P - ρ g z ) ) = w \qquad ( 7 )$$
where n denotes a porosity, s denotes a saturation, p denotes a fluid density, w denotes an infiltration supply volume, k denotes an absolute permeability, kᵣ denotes a relative permeability, μ denotes a fluid viscosity coefficient, P denotes a pressure, g denotes a gravity acceleration and z denotes an elevation water head;
b, the solute transport control equation is derived according to a mass conservation law and is represented that,
$$\frac{\partial ( n ( {C}_{j} + {\sum }_{i = 1}^{{N}_{i}} {υ}_{j i} {C}_{i}^{′} ) )}{\partial t} + ∇ ( q - nsD ∇ ) ( {C}_{j} + {\sum }_{i = 1}^{{N}_{i}} {υ}_{j i} {C}_{i}^{′} ) = {Q}_{j} - {\sum }_{m = 1}^{M} {υ}_{j m}^{′} {I}_{m} \qquad ( 8 )$$
where Cⱼ denotes a concentration of particles j, Cᵢ′ denotes a concentration of secondary species particles i corresponding to the particles j, νⱼᵢ denotes a stoichiometric number of all particles j and particles i related to liquid phase reactions, Nᵢ denotes a total number of the secondary species particles i, q denotes a groundwater flow velocity, D denotes a molecular diffusion tensor, Qⱼ denotes a source-sink phase of the particles j, Iₘ denotes a mineral reaction rate, νⱼₘ′ denotes a stoichiometric number of the particles j related to mineral phase reactions, M denotes a total number of the particles j related to the mineral phase reactions;
c, a mineral phase reaction rate Iₘ is obtained and calculated by the mass conservation law, specifically,
$${I}_{m} = \frac{1}{{\overline{V}}_{m}} \frac{\partial {φ}_{m}}{\partial t} \qquad ( 9 )$$
where φₘ denotes a mineral volume fraction, V̅ₘ denotes a mineral molar volume; and
d, a quantitative relation between the concentration Cⱼ of the particles j of a same type and the concentration Cᵢ′ of the secondary species particles i corresponding to the particles j is obtained according to a mass and energy conservation law of an equilibrium reaction, specifically,
$${C}_{i}^{′ \frac{{γ}_{i}}{{K}_{i}}} = {\prod }_{j} {( {γ}_{j} {C}_{j} )}^{{υ}_{j i}} \qquad ( 10 )$$
where Kᵢ denotes a reaction equilibrium constant of the secondary species particles i, γⱼ denotes an activity coefficient for the particles j and γᵢ denotes an activity coefficient for the secondary species particles i corresponding to the particles j.

6. A system for simulating a transport of a reactive solute in groundwater in a three-dimensional fracture network, wherein the system includes
a model parameter collection module, wherein the model parameter collection module is configured to collect geological structure data of a fracture block in a target research region and local hydrogeological parameters for the target research region;
a three-dimensional fracture network construction module, wherein the three-dimensional fracture network construction module is configured to model and parameterize the geological structure data according to geological structure data, which is collected, set lithology parameters for a stratum, generate a discrete fracture network, and upscale a plane fracture grid to a three-dimensional cubic grid and map the three-dimensional cubic grid into an equivalent continuum porous medium, and divide the equivalent continuum porous medium into a three-dimensional fracture body grid to establish a geological structure model for a research region;
a groundwater flow module, wherein the groundwater flow module is configured to determine an initial water head condition, a boundary condition, permeability coefficients for fractures and a fracture body based on the geological structure model, which is established, according to collected hydrogeological parameters, and solve a spatiotemporal distribution of a groundwater level in the research region and obtain an initial groundwater flow field;
a solute transport module, wherein the solute transport module is configured to set physical and chemical parameters for pollutants and a source-sink phase condition based on the initial groundwater flow field, which is obtained, and determine a spatiotemporal distribution of a solute concentration in the fracture groundwater; and
a fracture reaction transport module, wherein the fracture reaction transport module is configured to set relevant chemical reaction parameters based on the solute transport model, couple a water flow field and a chemical field to each other according to a basic equation of a mass and energy conservation, a seepage field equation, and a solute transport control equation, solve a result for the transport of the reactive solute in a fracture medium driven by a hydrodynamic and a hydrogeochemical reaction, and complete a simulation of transport values for the reactive solute in the groundwater in the three-dimensional fracture network.

7. The system for simulating the transport of the reactive solute in the groundwater in the three-dimensional fracture network according to claim 6, wherein data include (1) a hydrogeological condition, a stratum lithology and a stratum thickness, an aquifer buried depth, an aquiclude buried depth, an aquifer thickness, an aquiclude thickness, spatial distributions of an aquifer and an aquiclude, a recharge-runoff-discharge condition of a hydrogeological unit, a groundwater ion content, groundwater flow rate and velocity, and a hydrogeochemical characteristic; (2) a fracture medium condition, an overall number of the fractures, a spatial distribution of the fractures, a fracture occurrence, a fracture opening degree, a fracture development depth, a fracture roughness, physical and chemical properties of a fracture filling and a fracture geological body, and a spatial distribution of permeability coefficients for a fracture network, in the target research region.

8. The system for simulating the transport of the reactive solute in the groundwater in the three-dimensional fracture network according to claim 6, wherein the three-dimensional fracture model is constructed that,
characteristic parameters for a three-dimensional fracture network geological structure model are determined by a discrete fracture network parameter control equation and a model upscaling grid division control equation, specifically,
(1) in the discrete fracture network parameter control equation,
a, a direction of a normal vector for a fracture surface is characterized by a von Mises-Fisher distribution function, specifically,
$$\overline{v} == \frac{κ \cdot {e}^{κ \cdot {\overline{v}}^{T} \cdot I}}{2 π ( {e}^{κ} - {e}^{- κ} )} \qquad ( 1 )$$
where ν̅ denotes a matrix of a mean normal vector for the fractures, κ denotes a density coefficient, T denotes a matrix transpose, and I denotes an identity matrix;
b, a truncated power law distribution is adopted by a fracture radius R, and the fracture radius R is defined by a following probability density function,
$$R = {( \frac{α}{{R}_{l}^{- α} - {R}_{u}^{- α}} )}^{- 2 - α} \qquad ( 2 )$$
where Rᵤ denotes an upper boundary of the fracture radius, Rₗ denotes a lower boundary of the fracture radius, and a denotes a constant coefficient;
c, a fracture opening degree φ is determined by an exponential function of the fracture radius, specifically,
$$ϕ = F \cdot {R}^{γ} \qquad ( 3 )$$
where both F and γ denote the parameter values related to a water permeability; and
d, a fracture permeability k is calculated based on the fracture opening degree φ, specifically,
$$k = \frac{{ϕ}^{2}}{12} \qquad ( 4 )$$
(2) in the model upscaling grid division control equation,
a, a fracture medium porosity n is calculated based on an opening degree of the fracture passing through each grid, specifically,
$$n = \frac{1}{l} {\sum }_{i = 1}^{N} {ϕ}_{i} \qquad ( 5 )$$
where l denotes a side length of a divided grid, N denotes a total number of the fractures passing through the divided grid, and φᵢ denotes an opening degree of an i-th fracture in a target grid and is calculated by Formula (3); and
b, the fracture medium permeability k_{f} is assigned with reference to a permeability of each of the fractures in the grid, specifically,
$${k}_{f} = {\sum }_{i = 1}^{N} {k}_{i} \qquad ( 6 )$$
where kᵢ denotes a permeability of the i-th fracture in the target grid and is calculated by Formula (4).

9. The system for simulating the transport of the reactive solute in the groundwater in the three-dimensional fracture network according to claim 6, wherein the set parameters for the pollutants include a groundwater background ion component, a groundwater background ion concentration, a pollution source ion component, a pollution source ion concentration, and a condition of a boundary of a source-sink phase, in Step SS5, the chemical reaction parameters include a reaction equation of a groundwater ion component and a reaction equilibrium constant of the groundwater ion component, a mineral component, a mineral volume fraction, a mineral reaction rate constant, and a mineral phase reaction specific surface area.

10. The system for simulating the transport of the reactive solute in the groundwater in the three-dimensional fracture network according to claim 6, a groundwater reactive solute transport model is constructed that,
a spatiotemporal evolution law of target pollutants in model driven by the hydrodynamic and the hydrogeochemical action is calculated and obtained by the seepage field equation, the solute transport control equation, and the mass and energy conservation equation, specifically,
a, the seepage field equation is
$$\frac{\partial }{\partial t} ( n s ρ ) - ∇ ( ρ \frac{k {k}_{r}}{μ} ∇ ( P - ρ g z ) ) = w \qquad ( 7 )$$
where n denotes a porosity, s denotes a saturation, p denotes a fluid density, w denotes an infiltration supply volume, k denotes an absolute permeability, kᵣ denotes a relative permeability, u denotes a fluid viscosity coefficient, P denotes a pressure, g denotes a gravity acceleration and z denotes an elevation water head;
b, the solute transport control equation is derived according to a mass conservation law and is represented that,
$$\frac{\partial ( n ( {C}_{j} + {\sum }_{i = 1}^{{N}_{i}} {υ}_{j i} {C}_{i}^{′} ) )}{\partial t} + ∇ ( q - nsD ∇ ) ( {C}_{j} + {\sum }_{i = 1}^{{N}_{i}} {υ}_{j i} {C}_{i}^{′} ) = {Q}_{j} - {\sum }_{m = 1}^{M} {υ}_{j m}^{′} {I}_{m} \qquad ( 8 )$$
where Cⱼ denotes the concentration of particles j, Cᵢ′ denotes a concentration of secondary species particles i corresponding to the particles j, νᵢⱼ denotes a stoichiometric number of all particles j and particles i related to liquid phase reactions, Nᵢ denotes a total number of the secondary species particles i, q denotes a groundwater flow velocity, D denotes a molecular diffusion tensor, Qⱼ denotes a source-sink phase of the particles j, Iₘ denotes a mineral reaction rate, νⱼₘ′ denotes a stoichiometric number of the particles j related to mineral phase reactions, M denotes a total number of the particles j related to the mineral phase reactions;
c, a mineral phase reaction rate Iₘ is obtained and calculated by the mass conservation law, specifically,
$${I}_{m} = \frac{1}{{\overline{V}}_{m}} \frac{\partial {φ}_{m}}{\partial t} \qquad ( 9 )$$
where φₘ denotes a mineral volume fraction, V̅ₘ denotes a mineral molar volume; and
d, a quantitative relation between the concentration Cⱼ of the particles j of a same type and the concentration Cᵢ′ of the secondary species particles i corresponding to the particles j is obtained according to a mass and energy conservation law of an equilibrium reaction, specifically,
$${C}_{i}^{′} \frac{{γ}_{i}}{{K}_{i}} = {\prod }_{j} {( {γ}_{j} {c}_{j} )}^{{υ}_{ji}} \qquad ( 10 )$$
where Kᵢ denotes a reaction equilibrium constant of the secondary species particles i, γⱼ denotes an activity coefficient for the particles j and γᵢ denotes an activity coefficient for the secondary species particles i corresponding to the particles j.
